(19) United States
(12) Patent Application Publication
(10) Pub. No.: US 2006/0003806 A1
(43) Pub. Date: Jan. 5, 2006

(54) Phone synchronization device and method of handling personal information

(75) Inventors: Jeffrey G. Weber, San Antonio, TX (US); J. Bradley Bridges, San Antonio, TX (US); Donna M. Harrison, San Antonio, TX (US)

Correspondence Address: TOLER & LARSON & ABEL L.L.P., 5000 PLAZA ON THE LAKE STE 265, AUSTIN, TX, 78746, US

(73) Assignee: SBC Knowledge Ventures, L.P.

(21) Appl. No.: 10/884,383

(22) Filed: Jul. 2, 2004

(51) Int. Cl. H04M 1/00; H04B 1/38

(52) U.S. Cl. 455/561; 455/574

(57) ABSTRACT

A phone synchronization device and method of synchronizing electronic address book data between multiple phone devices is disclosed. In a particular embodiment, the phone synchronization device includes a housing having a support base, a first phone device reception slot, and a second phone device reception slot. The first phone device reception slot includes a first data synchronization port configured to receive and transmit data with respect to a first phone device when the first phone device is disposed within the first phone device reception slot and is in electrical contact with the first data synchronization port. The second phone device reception slot includes a second data synchronization port configured to receive and transmit data with respect to a second phone device when the second phone device is disposed within the second phone device reception slot and is in electrical contact with the second data synchronization port. The phone synchronization device also includes a synchronization data communication bus that is coupled to the first synchronization port and that is coupled to the second synchronization port.

### BACKGROUND

1. Field of the Disclosure

The present disclosure relates generally to data synchronization and more specifically to phone synchronization devices and methods of handling personal address book information for such devices.

2. Description of the Related Art

Local wireless communication devices, such as cordless or patio type telephones, have routinely included basic phone number directories. Such basic phone number directories allow a cordless phone user to store a set of names and associated phone numbers. The phone number directory may be accessed by the user at a later time to provide for convenient retrieval of phone numbers and often provides for automatic dialing of a selected phone number for a desired contact.

Cellular telephones offer address book functionality that includes a richer set of information when compared to the basic phone directory of the cordless telephone. The address book functionality is often also referred to as a contact list. The address book provides contact names and other information, such as physical address, title of contact, business name, cellular, landline, home phone numbers, and email addresses for the contact. For a user of both a cordless telephone and a cellular telephone, it is often inconvenient to input phone number data into both the cordless telephone and into the separate cellular telephone address book. Also, to the extent that cordless telephones are enhanced to provide address book functionality similar to that found in cellular phones, it would be desirable to provide an easy to use system and method for programming and synchronization of address books of multiple devices.

Accordingly, there is a need for a phone synchronization device and method of handling personal information for multiple types of phone devices.

### BRIEF DESCRIPTION OF THE DRAWINGS

FIG. 1 is a general diagram that illustrates a particular embodiment of a phone synchronization device.

FIG. 2 is a block diagram that illustrates functionality within a phone synchronization device.

FIG. 3 is a flow chart that illustrates a method of operation of a phone synchronization device.

### DETAILED DESCRIPTION OF THE DRAWINGS

A phone synchronization device and method of synchronizing electronic address book data between multiple phone devices is disclosed. In a particular embodiment, the phone synchronization device includes a housing having a support base, a first phone device reception slot, and a second phone device reception slot. The first phone device reception slot includes a first data synchronization port configured to receive and transmit data with respect to a first phone device when the first phone device is disposed within the first phone device reception slot and is in electrical contact with the first data synchronization port. The second phone device reception slot includes a second data synchronization port configured to receive and transmit data with respect to a second phone device when the second phone device is disposed within the second phone device reception slot and is in electrical contact with the second data synchronization port. The phone synchronization device also includes a synchronization data communication bus that is coupled to the first synchronization port and coupled to the second synchronization port.

Optionally, an external dongle attachment to the housing may be provided. The external dongle attachment may be coupled to the housing via an extension wire. The external dongle attachment has an external device connector to attach to an external communication device having an electronic address book. The optional dongle attachment allows synchronization of additional types of devices and those devices from different manufacturers that may require different connectors. In a particular embodiment, the second phone device reception slot may be replaced by the use of an external device data port attached to an external dongle attachment.

As another option, one of the phone devices, such as a cellular phone, may initiate forwarding of incoming calls to the second phone device, such as a cordless phone, upon detection that the cellular phone has been received within a slot of the phone synchronization device. This allows a user to have calls automatically transferred from their cellular phone to their cordless phone when the user returns home and places their cellular phone in the phone synchronization cradle.

In a particular embodiment, the method includes detecting docking of a first phone device having a first address book within a first reception location within a phone synchronization cradle, detecting docking of a second phone device having a second address book within a second reception location within the phone synchronization cradle, and initiating data synchronization to synchronize data between the first address book and the second address book. In a particular embodiment, the first phone device is a first type of device, such as a cordless telephone, and the second phone device is a second type of device, such as a cellular telephone. The method may also further include communicating data between the first phone device and the second phone device locally using an internal data bus located within the housing of the phone synchronization cradle to avoid the need to use or have access to an external network.

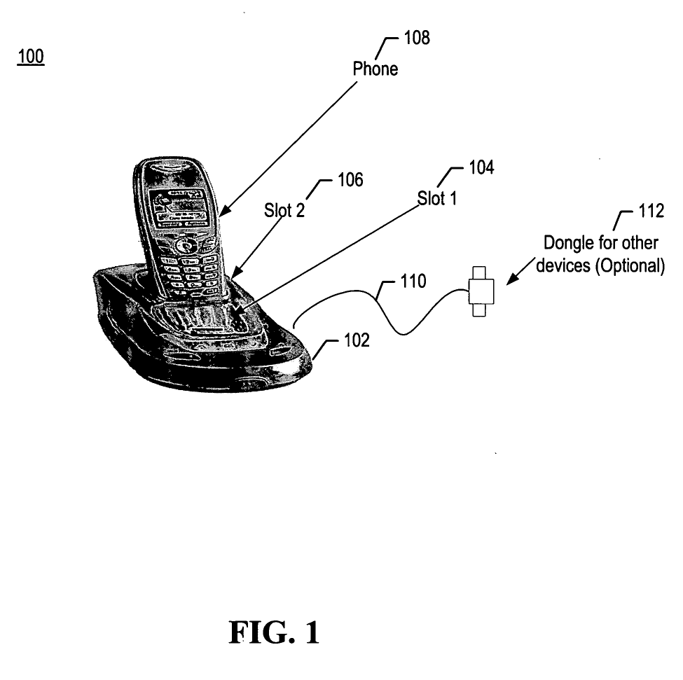

Referring to FIG. 1, an illustrative embodiment of a phone synchronization device 100 is shown. The phone synchronization device 100 includes a housing 102 having a base and having a first phone slot 104 and a second phone slot 106. The housing is connected via wire 110 to an external dongle attachment for other devices 112. A cordless phone 108 is shown as inserted in the second slot 106. The first slot 104 is configured to receive a portable device, such as a cellular phone. The phone synchronization device enables users of hand held devices to synchronize data on such devices. Examples of such data includes address books, contact lists, calendars, buddy lists and preferences across cordless and cellular phones.

In addition, internet connectivity is not required to provide data synchronization since the data is communicated between the first slot and the second slot via an internal communication bus. Data synchronization may also be provided across a variety of other devices such as wired phone, PDA, or hand held computer using the optional dongle attachment 112. In addition, in a particular embodiment, a charger may be provided to charge a battery within the hand held device as well as providing the data synchronization functionality.

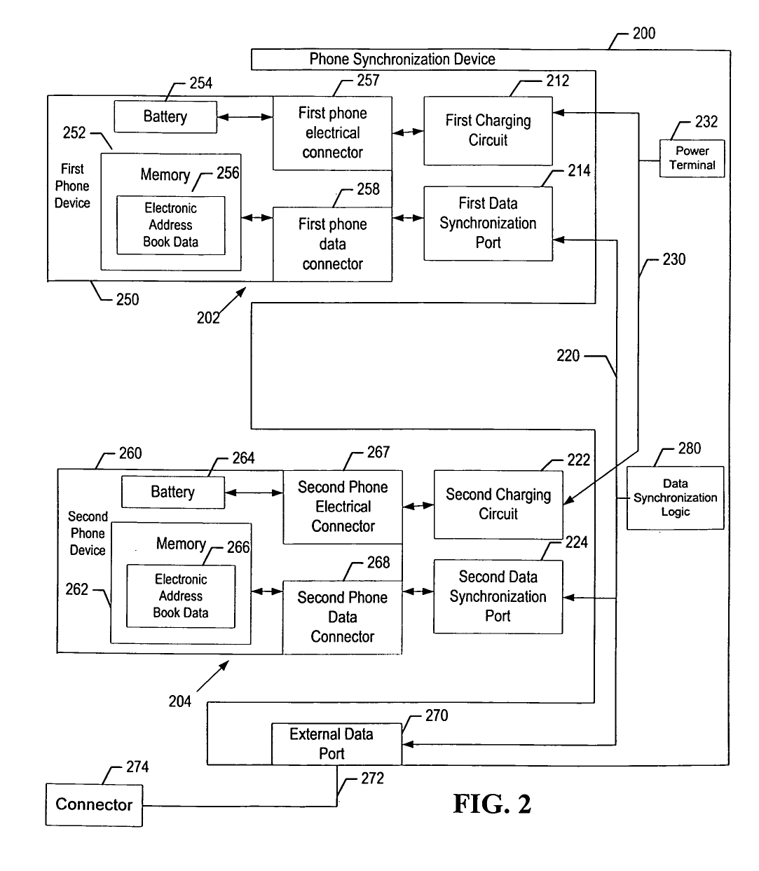

Referring to FIG. 2, an illustrative embodiment of a phone synchronization device functionality is shown. The phone synchronization device 200 includes a first phone receiving slot 202 and a second phone receiving slot 204. The first phone receiving slot 202 includes a first charging circuit 212 and a first data synchronization port 214. Similarly, the second phone receiving slot 204 includes a second charging circuit 222 and a second data synchronization port 224. The first and second charging circuits 212, 222 are coupled to each other and coupled to a power terminal 232 to provide for power to the charging circuits. Alternatively, charging may also be provided by the dongle attachment. The first data synchronization port 214 is coupled via an internal data communication bus 220 to the second data synchronization port 224 and also to the optional external data port 270.

The external data port 270 is linked to an external connector 274, such as the dongle attachment via wire extension 272. In a particular embodiment, the dongle attachment 274 can have a replaceable adapter at its end to connect to different types of phone devices. While a wired dongle attachment 274 is shown, the dongle may also be configured for insertion into one of the phone reception slots. In this manner, a phone slot with the inserted dongle can receive multiple types of phone devices.

A first phone device 250 may be inserted into the first phone receiving slot 202. As illustrated, the first phone device includes a battery 254 and includes a memory having electronic address book 256. The first phone device 250 also includes a first phone electrical connector 257 and a first phone data connector 258. When the first phone device 250 is inserted and docked in the phone receiving slot 202, the first phone electrical connector 257 is coupled to the first charging circuit 212 and the first phone data connector 258 is coupled to the memory 252 storing electronic address book data 256 and is coupled to the first data synchronization port 214. In this configuration, the first charging circuit 212 may provide additional charge via the first phone electrical connector 257 to the internal battery 254 of the first phone device 250. In addition, data may be communicated between the electronic address book 256 and the first data synchronization port 214 via the first phone data connector 258.

Similarly, a second phone device 260 including battery 264 and electronic address book 266 may be inserted into the second phone receiving slot 204. The second phone device 260 includes a second phone electrical connector 267 coupled to the battery 264. In addition, the second phone device 260 includes a second phone data connector 268 coupled to the memory 262 storing electronic address book data 266. The second phone data connector 268 and the second phone electrical connector 267 are respectively coupled to the second data synchronization port 224, and the second charging circuit 222 as shown when the second phone device 260 is docked within the phone reception slot 204.

In a particular embodiment the first phone device 250 may be a cellular phone and the second phone device 260 may be a cordless telephone. Other optional devices may also be received by the phone synchronization device 200, such as a personal digital assistant (PDA), wired telephones, and other hand held communication devices including electronic address books. After the first and second phone devices 250, 260, have been docked within the phone synchronization device 200, data from the electronic address books of such devices may be synchronized to one another. For example, data from electronic address book 256 may be passed through the first phone data connector 258 via the first data synchronization port 214 over the internal communication data bus 220 to the second data synchronization port 224. Such data is then further communicated over the second phone data connector 268 to the electronic address book 266 within the second phone device 260.

Alternatively, data from the second phone device electronic address data book 266 may pass in the other direction over the communication bus 220 and the data synchronization ports to provide for updated synchronization of the first phone device 250 with respect to the second phone device 260. In addition, other external devices connected to data connector 274 may pass synchronization data over external data port 270 and data communication bus 220 to either the first phone device or the second phone device via the data synchronization port when such phone devices are docked in the respective receiving slots. As shown the phone synchronization device 200 includes a data synchronization logic unit 280 coupled to the internal data communication bus 220. The data synchronization logic unit 280 may be implemented as software stored within a computer processor programmed to provide for data synchronization between the various hand-held devices that may be inserted in their respective receiving slots. While such data synchronization logic is shown as being within an internal microprocessor or similar computer device located within the phone synchronization device, it should be understood that such logic may be provided by a host computer attached externally to the phone synchronization device.

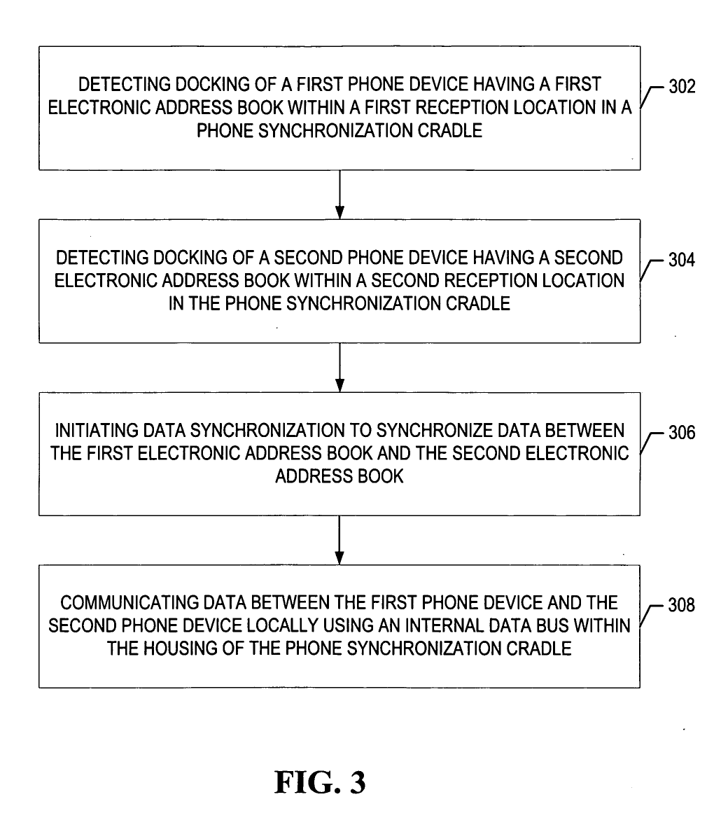

Referring to FIG. 3, a method of operation with respect to a phone synchronization device is shown. The method of phone synchronization includes detecting docking of a first phone device having a first electronic address book within a first reception location in a phone synchronization cradle, as shown at 302. The method further includes detecting docking of a second phone device having a second electronic address book within a second reception location in the phone synchronization cradle, at 304. Data synchronization is initiated to synchronize data between the first electronic address book and the second electronic address book of the first and second phone devices respectively, at 306. Data is then communicated between the first phone device and the second phone device locally using an internal data bus that is located within the housing of the phone synchronization cradle, as shown at 308.

A system and method of providing synchronization of electronic address book data of hand held devices such as cellular and cordless phones has been illustrated. The disclosed method and system uses an internal communication data bus to avoid the need for an internet connection or other network connection. Thus, a portable synchronization device may be used to provide for synchronization for various user devices having electronic address book data and similar contact information. In addition, the hand-held devices may have their batteries charged while data synchronization is being applied. Data that may be synchronized includes contact list information, calendar information, buddy list information, and user preference information. In addition, while a dongle attachment has been shown as an additional option, it should be understood that one of the slots of the phone synchronization device may be replaced by a dongle attachment. In this embodiment, a single reception slot would be used and a second device for data synchronization would be attached to the external dongle attachment. In addition, it should be understood that the synchronization process may be triggered automatically in response to detecting docking of the first phone device in the first phone device reception slot and in response to detecting docking of the second phone device in the second phone reception slot. Alternately, a synchronization event may be triggered manually by a user of the device.

In another illustrative embodiment, one of the phone devices, such as a cellular phone, may include call forwarding logic to initiate forwarding of incoming calls to the second phone device, such as a cordless phone, upon detection that the cellular phone has been received within a slot of the phone synchronization device. The detection of placement into the slot may be determined in response to an electrical signal sent to the cellular phone upon connection to an electrical connector within the phone receiving slot. In addition, the cellular phone may initiate call forwarding by sending a wireless data message to a cellular base station or other similar wireless equipment that supports the cellular phone. An example of a messaging protocol is the SMS messaging system. Upon detection of the message from the cellular phone, the cellular equipment can initiate a feature to forward future calls addressed to the cellular phone to instead by routed to the cordless telephone. This allows a user to have calls automatically transferred from their cellular phone to their cordless phone when the user returns home simply by placing their cellular phone in the phone synchronization cradle. Thus, the cellular phone can have electronic address book data synchronized and can be charged while also having calls conveniently forwarded to a co-located cordless phone.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A phone synchronization device comprising:
a housing having a support base, a first phone device reception slot, and a second phone device reception slot,
the first phone device reception slot including a first data synchronization port configured to receive and transmit data with respect to a first phone device when the first phone device is disposed within the first phone device reception slot and is in electrical contact with the first data synchronization port,
the second phone device reception slot including a second data synchronization port configured to receive and transmit data with respect to a second phone device when the second phone device is disposed within the second phone device reception slot and is in electrical contact with the second data synchronization port, and
a synchronization data communication bus, the synchronization data communication bus coupled to the first synchronization port and coupled to the second synchronization port to carry transmission of synchronization data between the first and second synchronization ports.

2. The phone synchronization device of claim 1, wherein the first phone device reception slot includes a first phone charging circuit to provide electrical charge to a battery within the first phone device.

3. The phone synchronization device of claim 1, wherein the second phone device reception slot includes a second phone charging circuit to provide electrical charge to a battery within the second phone device.

4. The phone synchronization device of claim 1, wherein the first phone device reception slot is configured to receive a first type of phone device and wherein the second phone device reception slot is configured to receive a second type of phone device.

5. The phone synchronization device of claim 4, wherein the first type of phone device is a cellular phone device and the second type of phone device is a cordless phone device.

6. The phone synchronization device of claim 4, wherein the first type of phone device is a wireless phone device and the second type of phone device is a computing device.

7. The phone synchronization device of claim 6, wherein the computing device is a personal digital assistant computing device.

8. The phone synchronization device of claim 1, wherein the first phone device includes a first electronic address book including a first set of address book data and wherein the second phone device includes a second electronic address book including a second set of address book data.

9. The phone synchronization device of claim 8, further comprising a processor including data synchronization logic to synchronize the first set of address book data and the second set of address book data such that both sets of address book data contain a common set of address book information.

10. The phone synchronization device of claim 9, wherein the common set of address book information includes contact list information, calendar information, buddy list information, and user preference information.

11. The phone synchronization device of claim 9, wherein the data synchronization logic is configured to provide data synchronization without relying upon external network communication and wherein the housing is disconnected from an external data network.

12. The phone synchronization device of claim 1, wherein the first phone device initiates call forwarding of incoming calls to the second phone device.

13. The phone synchronization device of claim 9, wherein the processor including the data synchronization logic is disposed within one of the first phone device and the second phone device.

14. The phone synchronization device of claim 9, wherein the processor including the data synchronization logic is disposed within the housing and is coupled to the synchronization data communication bus.

15. The phone synchronization device of claim 14, wherein initiation of synchronization is triggered automatically in response to detecting docking of the first phone device within the first phone device reception slot and detecting docking of the second phone device within the second phone device reception slot.

16. The phone synchronization device of claim 14, wherein synchronization initialization is triggered manually.

17. A method of synchronizing electronic address book data between multiple phone devices, the method comprising:
detecting docking of a first phone device having a first address book within a first reception location within a phone synchronization cradle;
detecting docking of a second phone device having a second address book within a second reception location within the phone synchronization cradle;
initiating data synchronization to synchronize data between the first address book and the second address book.

18. The method of claim 17, wherein the first phone device is a first type of device and the second phone device is a second type of device.

19. The method of claim 18, wherein the second type of device is a computing device having phone features.

20. The method of claim 19, where the computing device is a personal digital assistant.

21. The method of claim 18, wherein the first type of device is one of a cellular telephone and a cordless telephone.

22. The method of claim 17, further comprising communicating data between the first phone device and the second phone device locally using an internal data bus within a housing of the phone synchronization cradle and without use of an external network.

23. A phone synchronization device comprising:
a housing having a support base, a first phone device reception slot and a second phone device reception slot,
the first phone device reception slot including a first data synchronization port configured to receive and transmit data with respect to a first phone device when the first phone device is disposed within the first phone device reception slot and is in electrical contact with the first data synchronization port,
the second phone device reception slot including a second data synchronization port configured to receive and transmit data with respect to a second phone device when the second phone device is disposed within the second phone device reception slot and is in electrical contact with the second data synchronization port,
a synchronization data communication bus, the synchronization data communication bus coupled to the first synchronization port and coupled to the second synchronization port to carry transmission of synchronization data between the first and second synchronization ports, and
an external dongle attachment, the external dongle attachment coupled to the housing via an extension wire, the external dongle attachment having an external device connector to attach to an external communication device having an electronic address book.

24. The phone synchronization device of claim 23, wherein the first phone device reception slot includes a first phone charging circuit to provide electrical charge to a battery within the first phone device and wherein the second phone device reception slot includes a second phone charging circuit to provide electrical charge to a battery within the second phone device.

25. The phone synchronization device of claim 23, wherein the first phone device reception slot is configured to receive a first type of phone device, the second phone device reception slot is configured to receive a second type of phone device, and the dongle attachment is configured to receive a third type of device.

26. The phone synchronization device of claim 25, wherein the first phone device includes a first electronic address book including a first set of address book data and the second phone device includes a second electronic address book including a second set of address book data.

27. The phone synchronization device of claim 26, further comprising a processor including data synchronization logic to synchronize the first set of address book data, the second set of address book data, and the external address book of the external device, such that all sets of address book data contain a common set of address book information.

28. The phone synchronization device of claim 27, wherein the common set of address book information includes contact list information, calendar information, buddy list information, and user preference information.

29. The phone synchronization device of claim 28, wherein the processor including the data synchronization logic is disposed within one of the first phone device, the second phone device, and the external device.

30. The phone synchronization device of claim 28, wherein the processor including the data synchronization logic is disposed within the housing and is coupled to the synchronization data communication bus.

31. An electronic address book data synchronization device comprising:
a housing having a support base;
a first phone device reception slot within a portion of the housing, the first phone device reception slot including a first data synchronization port configured to receive and transmit data with respect to a first phone device when the first phone device is disposed within the first phone device reception slot and is in electrical contact with the first data synchronization port;
a second data port coupled to an external dongle attachment via an extension wire; and
a synchronization data communication bus, the synchronization data communication bus coupled to the first synchronization port and coupled to the second data port and configured to carry transmission of synchronization data between the first phone device and an external communication device having an electronic address book attached to the external dongle attachment.
